(19) United States
(12) Patent Application Publication
(10) Pub. No.: US 2025/0256717 A1
(43) Pub. Date: Aug. 14, 2025

(54) CONTROL DEVICE FOR VEHICLE

(71) Applicant: TOYOTA JIDOSHA KABUSHIKI KAISHA, Toyota-shi (JP)

(72) Inventor: Akito UCHIDA, Toyota-shi (JP)

(73) Assignee: TOYOTA JIDOSHA KABUSHIKI KAISHA, Toyota-shi (JP)

(21) Appl. No.: 18/980,239

(22) Filed: Dec. 13, 2024

(30) Foreign Application Priority Data
Feb. 13, 2024 (JP) 2024-019694

(51) Int. Cl. B60W 30/14; B60W 30/182

(52) U.S. Cl. CPC B60W 30/146; B60W 30/182; B60W 2520/10

(57) ABSTRACT

A control device, for a vehicle, includes a limitation process unit configured to execute a vehicle speed limitation process for limiting a vehicle speed to an upper limit vehicle speed by controlling a traveling power source of the vehicle to limit a driving force of the vehicle to an upper limit driving force, when the vehicle speed is higher than the upper limit vehicle speed, and a switching unit configured to switch the upper limit vehicle speed from a first speed to a second speed higher than the first speed, when a traveling mode of the vehicle is switched to a circuit mode.

### CROSS-REFERENCE TO RELATED APPLICATION

This application is based upon and claims the benefit of priority of the prior Japanese Patent Application No. 2024-019694, filed on Feb. 13, 2024, the entire contents of which are incorporated herein by reference.

### TECHNICAL FIELD

The present disclosure relates to a control device for a vehicle.

### BACKGROUND

There is a vehicle that switches a traveling mode to a circuit mode (see, for example, Japanese Unexamined Patent Application Publication No. 2015-199382).

When the vehicle speed is higher than the upper limit vehicle speed, the vehicle speed is limited to the upper limit vehicle speed by limiting the driving force of the vehicle to a predetermined upper limit driving force. For example, when the traveling mode is switched to the circuit mode, if the vehicle speed is limited to the same upper limit vehicle speed as when the traveling mode is other than the circuit mode, the traveling performance of the vehicle might not be exhibited.

### SUMMARY

It is therefore an object of the present disclosure to provide a control device for a vehicle that exhibit traveling performance of the vehicle in the circuit mode.

The above object is achieved by a control device for a vehicle, including: a limitation process unit configured to execute a vehicle speed limitation process for limiting a vehicle speed to an upper limit vehicle speed by controlling a traveling power source of the vehicle to limit a driving force of the vehicle to an upper limit driving force, when the vehicle speed is higher than the upper limit vehicle speed; and a switching unit configured to switch the upper limit vehicle speed from a first speed to a second speed higher than the first speed, when a traveling mode of the vehicle is switched to a circuit mode.

In a case where a required driving force for the vehicle is smaller than the upper limit driving force at a time when the vehicle speed is higher than the upper limit vehicle speed, the limitation process unit may be configured to set the upper limit driving force to the required driving force at a time when the vehicle speed is higher than the upper limit vehicle speed.

The limitation process unit may be configured to gradually decrease the upper limit driving force while the vehicle speed is higher than the upper limit vehicle speed, and the limitation process unit may be configured to gradually increase the upper limit driving force while the vehicle speed is equal to or lower than the upper limit vehicle speed.

The limitation process unit may be configured to stop the vehicle speed limitation process, when the required driving force is equal to or smaller than the upper limit driving force and when the vehicle speed is equal to or lower than the upper limit vehicle speed.

The traveling power source may be an engine.

### BRIEF DESCRIPTION OF THE DRAWINGS

FIG. 1 is a schematic configuration view of a vehicle;

FIG. 2 is a timing chart illustrating a vehicle speed limitation process;

FIG. 3 is a timing chart illustrating a vehicle speed limitation process during traveling on a downhill slope; and

FIG. 4 is a flowchart illustrating an example of a vehicle speed limitation process.

### DETAILED DESCRIPTION

### Schematic Configuration of Vehicle

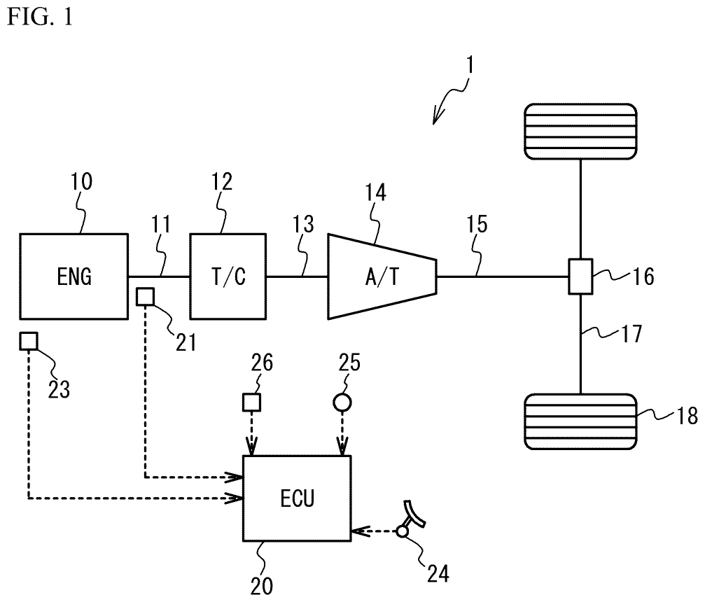

FIG. 1 is a schematic view illustrating a schematic configuration of a vehicle 1. The vehicle 1 includes an engine (ENG) 10, a torque converter (T/C) 12, and a stepped automatic transmission (A/T) 14. The engine 10 is a gasoline engine, but may be a diesel engine. The torque converter 12 is connected to a crankshaft 11 of the engine 10. A turbine shaft 13 of the torque converter 12 is connected to an input side of the automatic transmission 14, and the driving force of the engine 10 is transmitted to the automatic transmission 14. An output shaft 15 of the automatic transmission 14 is connected to a differential gear 16 that is a final reduction gear. The differential gear 16 is connected to left and right shafts 17. The driving force transmitted to the output shaft 15 is transmitted to driving wheels 18 via the shafts 17.

The Electronic Control Unit (ECU) 20 performs control processes related to the vehicle 1. The ECU 20 is a computer including a central processing unit (CPU), a random access memory (RAM), and a read only memory (ROM). The ECU 20 is an example of a control device for a vehicle, and functionally achieves a limitation process unit and a switching unit, which will be described in detail later.

A crank angle sensor 21, an air flow meter 23, an accelerator opening sensor 24, a mode changeover switch 25, and a vehicle speed sensor 26 are connected to the ECU 20, and outputs of these sensors are input to the ECU 20. The crank angle sensor 21 detects the speed of the engine 10. The air flow meter 23 detects the intake air amount of the engine 10. The accelerator opening sensor 24 detects an accelerator opening degree that is an opening degree of an accelerator pedal. The mode changeover switch 25 switches a traveling mode to be described later. The vehicle speed sensor 26 detects the traveling speed of the vehicle 1.

The ECU 20 calculates a required torque for the engine 10 based on the speed of the engine 10, the intake air amount, and the accelerator opening degree detected by the above-described sensors. The ECU 20 controls the fuel injection amount, the intake air amount, and the ignition timing of the engine 10 so that the torque outputted from the engine 10 becomes the required torque. For example, when the engine 10 is in an idle operation state, the ECU 20 controls the fuel injection amount, the intake air amount, and the ignition timing so that the speed of the engine 10 becomes a target idle rotational speed.

The ECU 20 switches the traveling mode to any one of a normal mode, a sport mode, an eco mode, and a circuit mode. The driver switches the traveling mode to the normal mode, the sport mode, or the eco mode by operating the mode changeover switch 25. Regarding the circuit mode, for example, when the vehicle 1 is in a circuit field, the driver operates a mobile terminal such as a smartphone to switch the traveling mode to the circuit mode. When the traveling mode is switched to circuit mode, the control map of the vehicle 1 is switched to a control map that prioritizes traveling performance corresponding to the circuit mode. This improves the traveling performance of the vehicle 1 as compared with the traveling modes other than the circuit mode. The switching to the circuit mode may be performed by the mode changeover switch 25 as described above.

The ECU 20 executes vehicle speed limitation process for limiting the vehicle speed to the upper limit vehicle speed when a predetermined condition is satisfied. In detail, when the speed of the vehicle 1 is higher than the upper limit vehicle speed, the ECU 20 controls the engine 10 as the traveling power source of the vehicle 1 to limit the driving force of the vehicle 1 to a predetermined upper limit driving force. More specifically, the required torque of the engine 10 is limited so that the driving force of the vehicle 1 becomes the upper limit driving force, and the fuel injection amount and the intake air amount are limited so that the actual torque of the engine 10 becomes the required torque. Thus, the vehicle speed is limited to the upper limit vehicle speed. The vehicle speed limitation process will be described in detail below.

### Vehicle Speed Limitation Process

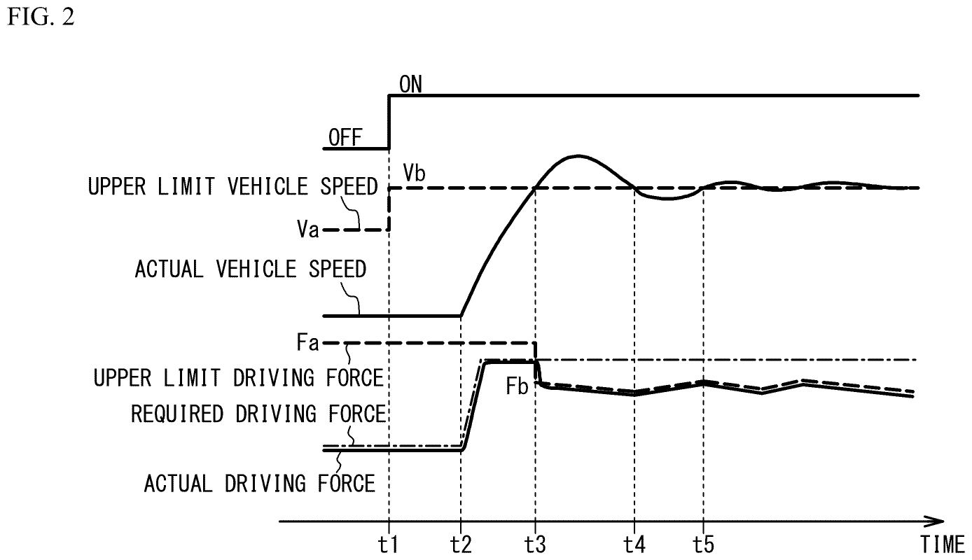

FIG. 2 is a timing chart illustrating the vehicle speed limitation process. FIG. 2 illustrates the transition of the ON/OFF state of the circuit mode, the actual vehicle speed, the upper limit vehicle speed, the actual driving force, the upper limit driving force, and the required driving force. The required driving force is a required value of the driving force of the vehicle 1 calculated based on the accelerator opening degree, the operating state of the engine 10, and the like.

When the traveling mode is switched to the circuit mode, the upper limit vehicle speed is switched to the high speed (time t1). Specifically, the upper limit vehicle speed is switched from the speed Va to a speed Vb higher than the speed Va. In this way, in the circuit mode, the vehicle 1 is capable of traveling at a speed higher than the speed Va and lower than the speed Vb. In this way, the traveling performance of the vehicle 1 is exhibited in the circuit mode.

When the required driving force increases in accordance with an increase in the accelerator opening degree by the driver, the actual driving force and the actual vehicle speed increase accordingly (time t2). When the actual vehicle speed is higher than the speed Vb of the upper limit vehicle speed, the upper limit driving force is set from the driving force Fa to the driving force Fb on the low driving force side, and the vehicle speed limitation process is executed (time t3). Thus, the actual driving force is limited to the driving force Fb, which is the upper limit driving force, regardless of the required driving force. The driving force Fb is set to a driving force such that the vehicle speed converges to the speed Vb, which is the upper limit vehicle speed. In this way, the actual vehicle speed is limited to the speed Vb, and safety is secured.

Further, while the actual vehicle speed is higher than the speed Vb, the upper limit driving force gradually decreases from the driving force Fb (time t3 to time t4). While the actual vehicle speed is equal to or lower than the speed Vb, the upper limit driving force gradually increases (time t4 to time t5). Thus, the upper limit driving force repeatedly decreases and increases. Therefore, the actual vehicle speed converges slowly to the speed Vb. This suppresses the occurrence of a shock in the vehicle 1 due to the execution of the vehicle speed limitation process.

The driving force Fa, which is set to the upper limit driving force before the actual vehicle speed is higher than the speed Vb, is the maximum driving force of the vehicle 1. That is, when the upper limit driving force is set to the driving force Fa, the driving force of the vehicle 1 is not limited to the driving force Fa. Therefore, when the upper limit driving force is the driving force Fa, the vehicle speed limitation process is not executed.

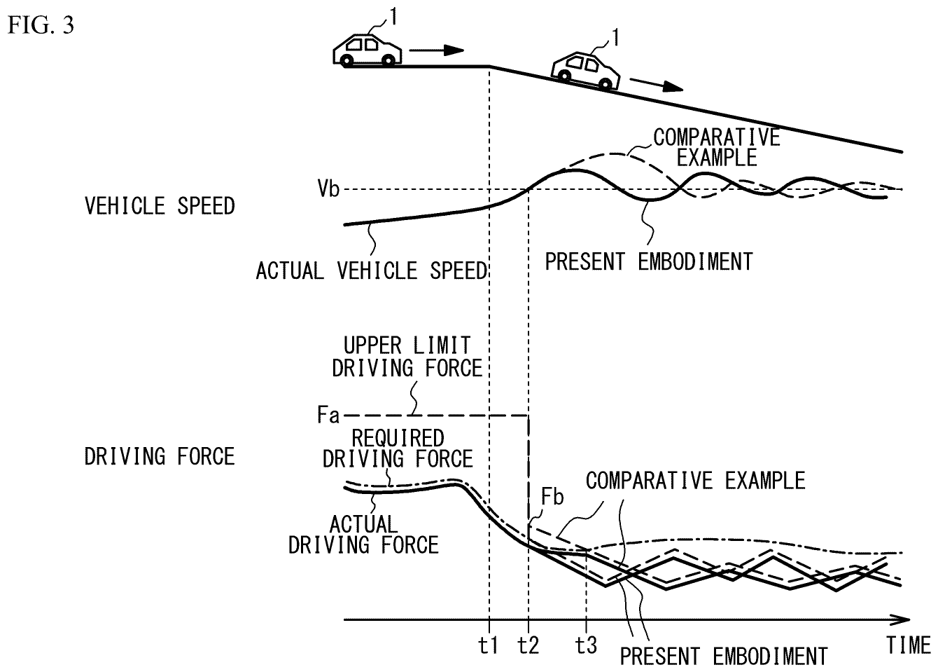

FIG. 3 is a timing chart illustrating an example of the vehicle speed limitation process during traveling on a downhill slope. When the vehicle 1 travels on a downward slope in the circuit mode, the actual speed increases, and the driver decreases the amount of depression of the accelerator pedal, whereby the required driving force decreases (time t1).

When the actual vehicle speed is higher than the speed Vb, the vehicle speed limitation process is executed (time t2). Here, the required driving force is smaller than the driving force Fb which is the upper limit driving force. A case where the upper limit driving force is set to the driving force Fb and the vehicle speed limitation process is executed even in such a case will be described as a comparative example. In the comparative example, the actual driving force is smaller than the driving force Fb, and therefore the actual driving force is not limited, and the vehicle speed is not limited. When the upper limit driving force gradually decreases from the driving force Fb and becomes equal to or smaller than the actual driving force, the actual driving force is limited (time t3). In this way, there is a time lag from when the actual vehicle speed is higher than the speed Vb until the limitation of the actual driving force is started. Therefore, it takes time for the actual vehicle speed to be limited to the speed Vb.

In the present embodiment, when the actual vehicle speed is higher than the speed Vb and the required driving force is smaller than the driving force Fb, the upper limit driving force is set to the required driving force (time t2). Thus, the limitation of the actual driving force is started at substantially the same timing as the timing at which the actual vehicle speed is higher than the speed Vb. Thus, the actual vehicle speed is limited to the speed Vb at an early stage.

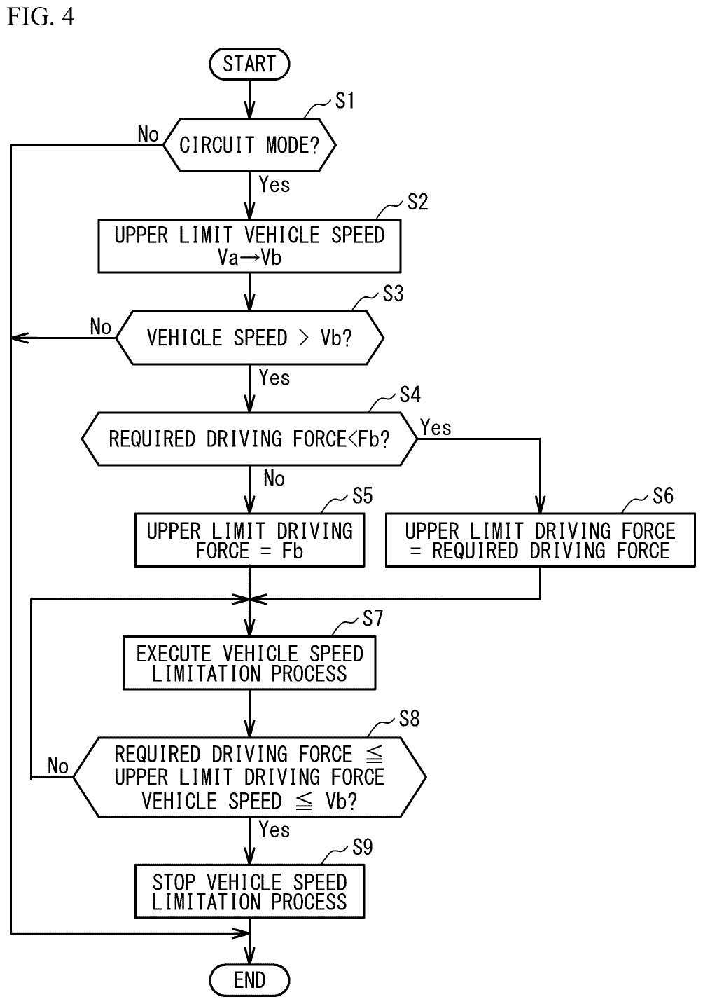

FIG. 4 is a flowchart illustrating an example of the vehicle speed limitation process. This control is continuously repeated while the ignition is on. The ECU 20 determines whether the traveling mode is switched to the circuit mode or not (step S1). If the determination result in step S1 is No, the control ends. If the determination result is Yes in step S1, the upper limit vehicle speed is switched from the speed Va to the speed Vb (step S2). Step S2 is an example of a process executed by the switching unit. Next, the ECU 20 determines whether or not the vehicle speed is higher than the speed Vb which is the upper limit vehicle speed (step S3). If the determination result in step S3 is No, the control ends.

If the determination result is Yes in step S3, the ECU 20 determines whether or not the required driving force is smaller than the driving force Fb which is the upper limit driving force (step S4). If the determination result is No in step S4, the ECU 20 sets the upper limit driving force to the driving force Fb (step S5). If the determination result is Yes in step S4, it is assumed that the vehicle 1 is traveling on a downward slope, and the ECU 20 sets the upper limit driving force to the required driving force (step S6). After the execution of step S5 or S6, the ECU 20 executes the vehicle speed limitation process with the switched upper limit driving force (step S7). Steps S5 to S7 are examples of processes executed by the limitation process unit.

Next, the ECU 20 determines whether or not the required driving force is equal to or smaller than the upper limit driving force and the vehicle speed is equal to or lower than the upper limit vehicle speed (step S8). If the determination result is No in step S8, the ECU 20 continues the vehicle speed limitation process (step S7). If the determination result is Yes in step S8, the ECU 20 stops the vehicle speed limitation process (step S9).

In the above embodiment, the ECU 20 mounted in the engine vehicle is described as an example of the control device for the vehicle. The vehicle on which such an ECU is mounted may be a hybrid vehicle including an engine and a motor as traveling power sources, or may be an electric vehicle including only a motor as a traveling power source.

Although some embodiments of the present disclosure have been described in detail, the present disclosure is not limited to the specific embodiments but may be varied or changed within the scope of the present disclosure as claimed.

What is claimed is:

1. A control device for a vehicle, comprising:
a limitation process unit configured to execute a vehicle speed limitation process for limiting a vehicle speed to an upper limit vehicle speed by controlling a traveling power source of the vehicle to limit a driving force of the vehicle to an upper limit driving force, when the vehicle speed is higher than the upper limit vehicle speed; and
a switching unit configured to switch the upper limit vehicle speed from a first speed to a second speed higher than the first speed, when a traveling mode of the vehicle is switched to a circuit mode.

2. The control device for the vehicle according to claim 1, wherein, in a case where a required driving force for the vehicle is smaller than the upper limit driving force at a time when the vehicle speed is higher than the upper limit vehicle speed, the limitation process unit is configured to set the upper limit driving force to the required driving force at a time when the vehicle speed is higher than the upper limit vehicle speed.

3. The control device for the vehicle according to claim 2, wherein
the limitation process unit is configured to gradually decrease the upper limit driving force while the vehicle speed is higher than the upper limit vehicle speed, and
the limitation process unit is configured to gradually increase the upper limit driving force while the vehicle speed is equal to or lower than the upper limit vehicle speed.

4. The control device for the vehicle according to claim 3, wherein the limitation process unit is configured to stop the vehicle speed limitation process, when the required driving force is equal to or smaller than the upper limit driving force and when the vehicle speed is equal to or lower than the upper limit vehicle speed.

5. The control device for the vehicle according to claim 4, wherein the traveling power source is an engine.
